(19) United States
(12) Patent Application Publication
(10) Pub. No.: US 2021/0337724 A1
(43) Pub. Date: Nov. 4, 2021

(54) PRODUCT AND PROCESS FOR ENABLING A CLOG-RESISTANT FEATURE IN A HAND-HELD LEAF RAKE

(71) Applicant: Garth Janke, Salem, OR (US)

(72) Inventor: Garth Janke, Salem, OR (US)

(21) Appl. No.: 16/781,695

(22) Filed: Feb. 4, 2020

Related U.S. Application Data
(63) Continuation of application No. 14/875,562, filed on Oct. 5, 2015, now abandoned.

(51) Int. Cl. A01D 7/06; G05B 19/4099; G06F 17/16

(52) U.S. Cl. CPC A01D 7/06; B33Y 50/02; G06F 17/16; G05B 19/4099

(57) ABSTRACT

Holes are provided in distal raking portions of the raking tines of an otherwise prior art leaf rake head for a hand-held leaf rake, to enable a clog-resistant feature in the leaf rake. The clog-resistant feature may be realized by threading a line, such as string trimmer line, through the holes.

### FIELD OF THE INVENTION

The present invention relates to a product and process for enabling a clog-resistant feature in a hand-held “lawn and garden” type leaf rake.

### BACKGROUND

Rakes commonly used for raking leaves typically have rake heads formed of metal or plastic, with plastic probably being the most common. FIG. 1 shows an example. An elongate handle, typically wooden, is attached to the rake head by inserting an end of the handle into a portion of the head defining a cavity, and the end is typically secured in the cavity with a screw to form the finished rake.

For purposes herein, a leaf rake will be defined as being a hand-held lawn and garden tool having an overall (maximum) length “L_{HA}”+“L_{HE}” between 40 and 74 inches with at least 60% of this length being devoted to the handle, and a total weight of less than 4 pounds, and commonly less than 2 pounds where the rake head is formed of plastic. For reference, in the rake shown in FIG. 1 the handle length L_{HA} is about 42 inches, the head length L_{HE} is about 21 inches, and the (maximum) width “W” of the head is about 24 inches. The maximum head width in a leaf rake can vary significantly, e.g., between about 6 and 30 inches.

The leaf rake is further defined to include a number of (e.g., more than ten and typically more than twenty) substantially identical and mutually independent and distinct “raking tines” extending from a common body portion “CB” of the head, roughly in a reference plane “REF” which contains the elongate axis of the handle (“handle axis) “HA.”

The rake head is typically not strictly planar—it often has slight curvature around either or both the handle axis and an axis perpendicular to the handle axis that also lies in the reference plane REF—but it is close enough to being planar for the descriptive purposes herein. Whether any such curvature is provided or not, the rake is substantially bilaterally symmetric about a plane (not shown) perpendicular to the reference plane and containing the handle axis HA.

Each “raking tine” (“RT”) is cantilever supported by the common body portion “CB” at respective proximal ends “E” of the raking tine, and which is unsupported at its distal end so that each raking tine is free to bend, out of the reference plane, about the cantilever supported end E, independent of the other raking tines.

More particularly with reference to FIG. 2, a raking tine may be defined as being, over its entire length, an elongate (long in relation to width) member, having an extending portion “EP” that extends substantially linearly a first distance “D₁” and defining a first elongate axis “L₁,” a raking portion “RP” that extends substantially linearly (it may have some curvature as indicated above) a second distance “D₂” and defining a second elongate axis “L₂,” and a distinct befit portion “BP” between the extending and raking portions extending over less than 20% of the length of the raking tine, and typically less than the distance D₂, the raking portion terminating in a “raking tip” “T” that is either blunt (as though the raking portion were cut off), or pointed, the first and second elongate axes being at an angle in the range of about 90-135 degrees as a result of a permanent bend provided by the bent portion, the first distance being relatively long compared to both the second and third distances (e.g., at least twice, and preferably at least three times as long), the third distance being typically about the same as or less than second distance. The cantilever support, together with the relatively long first distance as compared to the second, facilitate desirable elastic (spring-like) bending of the raking tine about the supported end E during the normal course of raking.

Each raking tine generally, and the raking portion of each raking tine specifically, has a relatively broad width dimension “w” (see FIG. 3) which for purposes herein will be taken to be about ¼-½ inches, and a relatively narrow thickness dimension “t,” which for purposes herein will be taken to be less than ⅛ inches, measured perpendicular to the width dimension. The broader width dimensions are oriented perpendicular to the direction of raking to increase the area of contact of the raking portions with the leaves.

The reduced thickness of the raking tines further facilitates bending of the raking tines during raking, making the raking tines more compliant, or “flexible” as that term is used herein, which increases raking efficacy. For this purpose, a raking tine will elastically (recoverably) bend about its supported end E such that, if a one-pound force oriented in a direction perpendicular to the reference plane (indicated by an arrow in FIG. 2) is applied to the raking tine at its raking tip T, the bent portion BP of that raking tine will be deflected (such as measured at the point “P” in FIG. 2) in the same direction by an amount which is at least ⅛ inch and which is typically at least ¼ inch relative to the bent portions of the other raking tines.

The reduced thickness of the raking portions also provides for increased raking pressure, which also increases raking efficacy, at least initially. But this feature also increases the tendency of the raking tips to spear the leaves, and with continued use of the rake the speared leaves tend to migrate up and past the raking portions, accumulating on the head, making the rake both heavier and therefore more difficult to use, and ultimately less effective. This is often referred to as “clogging.”

Three general strategies have been used to address the problem of clogging in a leaf rake. The first of these is by far the most common, which is to simply to clean the rake as it becomes clogged during use. Which adds significantly to the labor of using the rake.

An example of the second strategy is provided in U.S. Pat. No. 4,776,158 to Baum, entitled “Self-Cleaning Leaf Rake.” But the rake is not “self” cleaning; rather, it provides a manually operated mechanism for clearing the rake of clogged debris. Which adds significantly to the weight and complexity to the rake, as well as adds to the effort to use it.

The third strategy is represented by the “Self-Cleaning Rake” disclosed in U.S. Pat. No. 6,009,697 to Billado. The raking portion of each raking tine is joined to the raking portion of the adjacent raking tine at a common raking tip which is shared between the two raking tines, closing off the space between the raking tines at the raking tip and thereby preventing speared leaves from migrating past the raking tip.

But tying the raking tines together at the raking tips makes them depend from one another, so that they are not free to bend independently of each other, and thus they are much less flexible than the raking tines in a standard leaf rake, making this type of rake generally less effective than a standard leaf rake for raking.

Accordingly, there is a need for a product and process for enabling a clog-resistant feature in a leaf rake.

### SUMMARY

A prior art leaf rake head has a plurality of independent raking tines extending from a common body portion of the head, wherein each raking tine is an elongate member first extending, thence turning through a distinct bent portion, and thence terminating in a raking tip, an elongate raking portion of the raking tine thus being defined between the bent portion and raking tip. The prior art leaf rake head is improved according to the present invention by providing, in at least a majority of the raking tines, at least one hole extending through and enclosed by the respective raking portion, for enabling a clog-resistant feature in a leaf rake.

The clog-resistant feature may be realized by threading a line through the holes, where the line may be string trimmer line.

The at least one hole may be one or more holes, but may be limited to one hole, or two spaced apart holes.

The head may be provided in the form of a single piece of material, such as plastic.

A process for enabling the clog-resistant feature may include using a computer to create a mathematical model of the rake head for use in a standard computer controlled tool such as a CNC router or 3D printer.

A “product by process” for enabling the clog-resistant feature may be achieved by use of any of the processes for making the rake head disclosed herein.

It is to be understood that this summary is provided as a means of generally determining what follows in the drawings and detailed description and is not intended to limit the scope of the invention. Objects, features and advantages of the invention will be readily understood upon consideration of the following detailed description taken in conjunction with the accompanying drawings.

### BRIEF DESCRIPTION OF THE DRAWINGS

FIG. 1 is a perspective view of a standard prior art leaf rake.

FIG. 2 is a side elevation of a typical prior art raking tine taken from the vantage point indicated as “V” in FIG. 1.

FIG. 3 is a perspective, cut-away view of a portion of a head for a leaf rake according to the invention providing for a clog-resistant feature.

FIG. 4 is a perspective, cut-away view of a raking tine with a first alternative provision for a clog-resistant feature according to the present invention.

FIG. 5 is a perspective, cut-away view of a pair of raking tines with a second alternative provision for a clog-resistant feature according to the present invention.

FIG. 6 is a block diagram of a computer-controlled processing system according to the present invention.

FIG. 7 is a cut-away, plan view of a line threaded through holes of the leaf rake head of FIG. 2 according to the present invention.

FIG. 8 is a cut-away, plan view of a line threaded through holes of the leaf rake head of FIG. 4 according to the present invention.

FIG. 9 is a cut-away, plan view of a line threaded through holes of the leaf rake head of FIG. 5 according to the present invention.

FIG. 10 is an “x-y” plot of a motion path for robotically threading the line as shower in either FIG. 7 or FIG. 9.

FIG. 11 is an “x-y” plot of a motion path for robotically threading the line as shown in FIG. 8.

### DETAILED DESCRIPTION OF PREFERRED EMBODIMENTS

As suggested in the discussion above, making the raking tines of the rake head thicker (e.g., circular in cross-section) would help to reduce clogging in the leaf rake, because it would reduce the tendency for the raking tines to spear the leaves. But making the raking tines thicker will also make them stiffer, i.e., less flexible or compliant, creating the disadvantage presented by the aforedescribed third strategy.

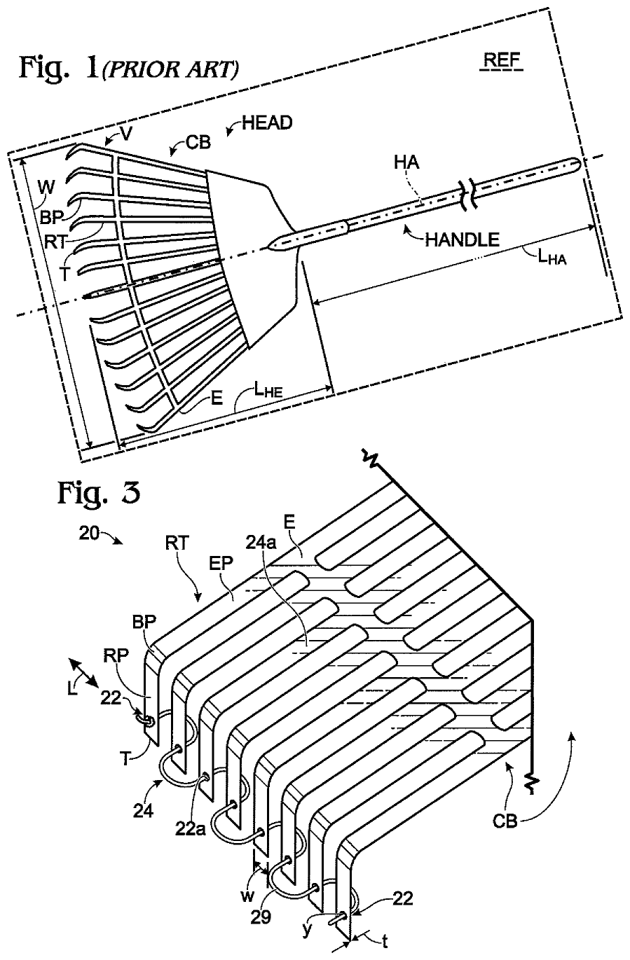

The present invention strives to maintain flexibility of the raking tines that is provided in the standard leaf rakes, such as that provided by the head shown in the rake of FIG. 1, while at the same time providing for significantly increased clog-resistance.

FIG. 3 shows a preferred embodiment of the invention, in which a raking head 20 may be identical to the prior art head shown in FIG. 1 except for the provision of holes 22 through the raking tines RT, located in the raking portions RP of the raking tines extending from the bent portions BP to the raking tips T.

The holes 22 are preferably located more specifically intermediate the bent portions and raking tips, and preferably closer to the tips than the bent portions. For example, the raking portions are typically about 1-1¼ inches long (bottom of bent portion to raking tip), so that the holes 22 are typically spaced less than ½-⅝ inches above the raking tips. Preferably, there is at least one hole through each raking tine; but it is not essential to have a hole through each raking tine, it being sufficient that, in at least a majority of the raking tines, there is at least one hole. In the present embodiment, there is only one hole per raking tine, e.g., a single hole 22a through the raking tine 24a.

A hole through a raking tine generally has a particular orientation. For purposes of defining the orientation, the hole may be defined as being elongate, such as may be produced by a drill but which need not be circular, so that it has an elongate axis, or “hole axis.” Then, the orientations of the holes as shown in the head 20 are such that the hole axes are perpendicular to the broad axes “L” of the raking tines through which they extend. The orientations of the holes are apparent from the direction of the line as it enters and exits the holes.

Note that the axes L are shown as being the same for all the raking tines, but this is a consequence of a simplification employed in FIG. 3 whereby all the raking tines are shown to be parallel. By inspection of FIG. 1, it should be appreciated that this need not be the case, and it is often not the case.

It is generally desirable that all the holes 22 be substantially the same size and shape, and be situated identically in each of the raking tines in which they are provided.

The holes 22 are provided so that a line 29 may be threaded through the holes such as shown in FIG. 3, which to a significant extent prevents leaves or other debris that may be speared by the tips T from migrating any farther up the raking tines than the locations of the holes. The line between adjacent raking tines forms “loops” 24 that are preferably about half-circular, implying that the length of the line between adjacent raking tines is preferably about 3 times the spacing between the tines. Preferably, the circumference of a loop is at least 1.5 times the spacing between the tines, more preferably at least twice this spacing.

The loops are capable of trapping some debris, as are the spaces between the raking tines, but the line significantly reduces both the amount of debris that is retained on the rake during use and the effort required to remove any debris that is retained, while providing the significant advantage of retaining most if not quite all of the flexibility of the raking tines, by allowing each raking tine to bend mostly if not completely independently of neighboring raking tines.

The term “line” as used herein refers to a filamentary material, which can be either a “monofilament,” generally meaning a single, continuous strand of material, or a “polyfilament,” generally meaning multiple strands of material that are twisted or braided. More specifically for purposes herein, the single strand of a monofilament is preferably formed of a plastic material (an example is fishing line), whereas the multiple strands of a polyfilament may be formed of either plastic or metal; however, the polyfilament line, if not formed of plastic strands, is preferably encased in plastic (an example is insulated stranded electrical wire).

The line should be tough enough to withstand the abuse it will encounter as the rake is being used, and flexible enough to allow the raking tines to bend substantially independently of one another, while not being so flexible that it cannot support itself in the looped configuration shown in FIG. 3.

The term “flexible” as used herein refers to flexibility in bending, or pliability; which is distinguished from “elasticity” or stretchy-ness. Unlike elasticity, flexibility is not a material property. For example, an optical fiber is flexible, even though the glass of which the optical fiber is formed is quite rigid, because of its configuration, i.e., because it is much longer than it is thick. Similarly, the line 29 between adjacent raking tines can be flexible without being elastic.

It is moreover preferable for the line 29 to have minimal elasticity (all materials are somewhat elastic), so that any debris that may become lodged inside a loop of the line 29 is not forcefully retained there, and so that the loop can be more easily pulled away from any object on which it may become snagged.

It is also preferable for the line 29 to be resistant to wetting, hence the plastic strands or casing for the polyfilament as described above.

A preferred line for use in the present invention is a monofilament, nominal 0.065 inch “string trimmer line,” a term that is used commercially to refer to the line used in the ubiquitous powered (gas or electric) hand-held gardening tool known as a “string trimmer.” It should be noted that string trimmer line is not “string” because it is not a polyfilament.

The numerical designation “0.065” as a size of string trimmer line refers to a nominal cross-sectional “diameter” of the line, it being understood that the cross-sectional shape of string trimmer line is not strictly circular, at least because string trimmer line includes projecting cutting edges. For purposes herein a selected diameter of a line, whether circular in cross-section or not, may be considered to define a “diametrical size” of the line, which may be either nominal or actual.

String trimmer line is available in larger diametrical sizes, such as 0.080, 0.095, and 0.155 inches, in decreasing order of preference because the larger sizes are increasingly less flexible.

As one alternative to string trimmer line (there may be others), insulated twisted strand electrical wire can be used. This is commercially provided in AWG (American Wire Gauge) sizes, e.g., 18, 16, and 14 gauge (increasing number referring to decreasing diametrical size), having nominal outer diameters that vary primarily as a result of variances in thickness of the insulation. As one example, Belden CDT Inc., of St. Louis, Mo., provides 18 AWG, 7×26 stranded tinned copper wire having an insulation thickness of 0.10 inches and overall nominal diameter of 0.068 inches (manufacturer part number 8501 001100) which closely corresponds in nominal diametrical size to the preferred 0.065 inch string trimmer line.

The preferred 0.065 inch string trimmer line can be used to benchmark flexibility. In increasing order of desirability (least desirable first), the line 29 may have a flexibility that is between one-third and 3 times that, between one-half and 2 times that, or between two-thirds and 1.5 times that, of 0.065 inch string trimmer line, however the flexibility may be measured.

The holes 22 are preferably “circular,” this term meaning that they have the shape of a circle. They are also “enclosed,” this term meaning that the holes are wholly encircled by the material through which they extend, with the practical result that the line 29 cannot escape from the holes except by passing through the holes.

For 0.065 inch string trimmer line, the holes 22 may have the diameter of a 5/64 or 0.078 inch diameter drill bit, corresponding to a projected or maximum area (i.e., along the hole axis) of 0.00478 square inches, which provides for a sufficiently loose fit to allow for easily threading the line through the holes by hand, but a sufficiently snug fit between the line and the holes to resist slippage of the line through the holes. The reason it is preferable to resist slippage will be explained further below. For 0.080 inch string trimmer line, the drill size would be 3/32 or 0.094 inches, corresponding to a projected area of 0.00694 square inches; for 0.095 inch string trimmer line, the drill size would be 7/64 or 0.109 inches, corresponding to a projected area of 0.00933 square inches; and for 0.155 inch string trimmer line, the drill size would be 11/64 or 0.172 inches, corresponding to a projected area of 0.023 square inches.

Preferably the area of each hole is in the range 0.002 and 0.023 square inches, to accommodate line having an actual diameter ranging between 0.037 and 0.170 inches; and more preferably the range is 0.002-0.010 square inches, biasing the upper end of the range toward thinner line because it is more flexible. More particularly, the line preferably has a diameter in the range 0.065+0.02/−0.01 inches, and where the hole has a diameter which is approximately 0.013 inches oversize, so that the diameter of the hole is between 0.068 and 0.098 inches, the hole area is still more preferably in the range 0.00478+0.003/−0.001 square inches.

Where the line has a circular cross-section having an actual diameter of 0.065 inches, approximating the preferred nominal diameter for the preferred string trimmer line, the cross-sectional area is 0.00332 square inches, establishing the same as a preferred lower limit on the hole size. A preferred upper limit may be established by taking the next preferred size of string trimmer line, 0.80 inch, which when including a 0.013 inch diameter increase results in a hole area of 0.00679 square inches. The resulting preferred range may be expressed as 0.00478 square inches (the preferred hole size assuming use of 0.065 inch string trimmer line)+0.002/−0.0015 inches.

It is not essential that the holes 22 be sized to facilitate threading the line through the holes by hand, because this process could be automated, in which case a snug or even a slightly interference fit could be provided. The holes should not be so large that they allow for ready slippage of the line through the holes. It is advantageous to avoid such slippage to avoid restricting the flexibility of the raking tines during vigorous use of the rake. That is, the flexibility of the raking tines will decrease as the length of the loops between the raking tines decreases, and slippage of the line through any given hole, while increasing the length of the loop on one side of the hole, will necessarily decrease the length of the loop on the other.

Where the holes are not circular, it will be understood that their areas would preferably be increased relative to the areas indicated above. For example, a square hole with a side length D has an area about 1¼ times larger than the area of an equivalent circle of diameter D. So to accommodate non-circular holes generally, any of the hole area dimensions described above may be increased by an appropriate factor, such as 1.2-1.5.

The aforementioned cutting edges on string trimmer line have been found to be helpful for securing the line in circular holes. Similarly, polygonal shapes may be preferred over circular shapes where the line has a circular cross-section (such as electrical wire). In both cases, there is a shape mis-match which tends to enhance stress concentration between the line and the surface of the raking portion defined by the hole, thereby reducing the tendency for slippage of the line through the holes. For the same reason, where polygonal shapes are employed for the holes, they would preferably have sides of equal length, e.g., a square as opposed to a rectangle, to maximize the number of regions of contact between the line and the surface of the raking portion defined by the hole over which stress is applied.

FIGS. 4 and 5 show, respectively, first and second alternative hole configurations 30 and 40. In FIG. 4, a single hole 22b is shown extending through a boss 32 in a raking tine “RTb;” and in FIG. 5, each raking tine has two holes; e.g., 22c₁ and 22c₂ for the raking tine “RTc,” and 22d₁ and 22d₂ for the raking tine “RTd.” Preferably, the holes in a given raking tine in the embodiment shown in FIG. 5 are spaced (center-to-center distance) between ¼ and ½ inches apart. These configurations minimize the loop area that projects forward of the raking tines.

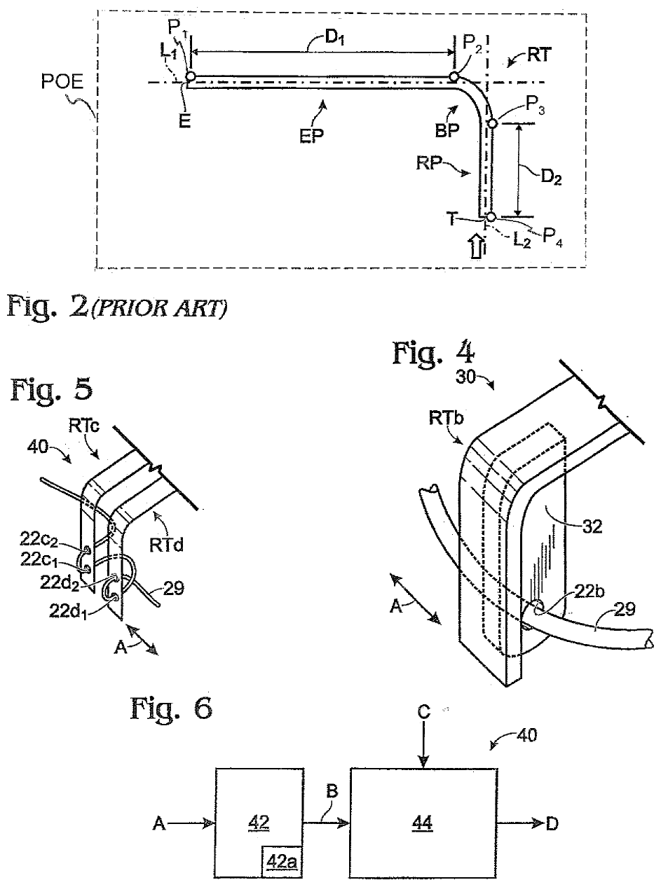

Regarding the embodiments 20 and 40, the holes are preferably perpendicular to the broad axes L of the raking tines, but their orientation may deviate significantly and still allow for satisfactorily threading the line 29 as shown in the corresponding FIGS. 2 and 5. Similarly regarding the embodiment 30, the holes are preferably parallel to the broad axes L of the raking tines, but their orientation may deviate significantly and still allow for satisfactorily threading the line as shown in FIG. 4. To distinguish the two cases for purposes of definition herein, a hole axis for a given raking tine that is closer to being perpendicular to the broad axis L of that raking tine than parallel shall be considered perpendicular, and a hole axis for a given raking tine that is closer to being parallel to the broad axis L of that raking tine than perpendicular shall be considered parallel.

As suggested in FIG. 2, the ends of the line 29 may simply be knotted to keep the ends from pulling through the holes 22 of the first and last raking tines (see, e.g., the hole referenced as 22₁ in FIG. 3). If more security is believed to be needed, a washer can be provided between a knot and the respective hole.

The inventor has made an A to B comparison of the same prior art leaf rake (substantially as shown in FIG. 1) with and without 0.065 string trimmer line as shown and described above in connection with the head 20, used to rake about 1500 pounds of oak leaves and related debris including twigs covered with moss, and saw a significant and greater than expected improvement in the rake's resistance to clogging.

Plastic embodiments of rake heads according to the invention may be the product of a process of plastic molding, which includes using one or more machine tools to create a mold of the head, and implementing the mold on a standard plastic molding machine.

Plastic molds and plastic molding, machines are well known in the art, and there is nothing unusual about the manner in which they would be used to achieve the purposes herein. But it may be worth noting that a plastic mold capable of manufacturing raking tines with holes will be more costly than the molds currently being used. To minimize the additional cost, it may be preferable to provide for all the hole axes to be parallel.

The heads are attached to handles after they are manufactured, in a final assembly process that is typically performed by the manufacturer of the leaf rake.

It is contemplated that the line 29 would also be installed after the heads are manufactured, either by the manufacturer or by the end-purchaser of the rake.

Rake heads according to the invention may be the product of processes that utilize CNC (computer numerical control) of CNC (computer numerically controlled) tools, which are a species of what will be referred to more generally herein as “computer-controlled devices or tools.” Computer-controlled devices and tools and the computers that control them are well known and there is nothing unusual about the manner in which they would be used to achieve the purposes herein.

A CNC router is a common type of computer-controlled device or tool for manufacturing a product. It performs what is known as “subtractive” manufacturing, by forming the product from a block of material by routing or otherwise removing material from the block where material is not needed.

A three dimensional or “3D” printer is another example of a computer-controlled device or tool for manufacturing a product. By contrast to a CNC device, a 3D printer performs “additive” manufacturing: forming the product by depositing or otherwise adding material where material is needed.

Computer-controlled devices or tools that are capable of making an entire product, like CNC routers and 3D printers, use mathematical models, which are created by use of computers and fixed or installed on or in on-board computer-readable media such as volatile or non-volatile computer memory, or removable or portable media such as CD-ROMs and thumb drives, as patterns or templates for making the product.

The mathematical model is, particularly, a “3D model,” and is created by a process known as “3D modeling” using 3D modeling software known as modeling applications or modelers. There are numerous commercial offerings of 3D modeling software which can be executed on a standard computer such as a PC or Mac. The modeling software allows the user to construct a set of mathematical relationships, a.k.a. mathematical formulas or equations, between position variables (such as the Cartesian coordinate system variables x, y, and z) defining the geometry of the product. For example, the mathematical relationship A₁·x+B₁·y+C₁·z=D₁ defines a plane, and a line can be defined by the intersection of this plane with a second plane A₂·x+B₂·y+C₂·Z=D₂ (the two equations with three variables imply one equation with two variables of the form (variable 1)=m·(variable 2)+b; where (variable 1)=y, and (variable 2)=x, this is the familiar y=mx+b mathematical relationship describing a line lying in the x-y plane). The mathematical relationships specified by a 3D model are analogous to “vector” representations in (two-dimensional) “vector graphics.”

Like all computer code, 3D models are physically represented by ordered arrays (stored in non-volatile memories) or ordered sequences (transmitted by electrical signals) of numbers (1's and 0's) for computer manipulation and implementation.

A 3D model may be created by “computer aided design” (CAD) software, which allows for including additional information, such as dimensions (or scale) and choices of materials.

The 3D model must be translated into a set of “device-specific” instructions, or algorithm, by use of additional software known as a “driver” for directing and controlling a particular computer-controlled device or tool to make a physical embodiment of the 3D model.

Like all computer code, device specific instructions or algorithms are represented by ordered arrays (stored in non-volatile memories) or ordered sequences (transmitted by electrical signals) of numbers (1's and 0's) for computer manipulation and implementation.

The driver solves a mathematical problem of transforming the mathematical descriptions of the 3D model into discrete “voxels,” which are analogous to a “pixels” in (two-dimensional) “raster graphics.” A voxel is a minimum sized volume at a particular location in space; for example, in a Cartesian coordinate system, it may be represented by the coordinates (xₖ+Δx, yₖ+Δy, zₖ+Δz) defining a rectangular prism having the volume Δx·Δy·Δz at the location specified by the value of “k.”

The voxels are assigned “yes” or “no” (1 or 0) values obtained by solving the equations of the 3D model, such as by averaging the values the solutions for all x, y, and z within the voxel. The voxels with their assigned values may be referred to as a “voxel model.”

The voxel model provides a simple specification of where in space there is to be, and where in space there is not to be, material. More particularly, if the computer-controlled device or tool performs subtractive manufacturing, the values of the voxels specify where material is or is not to be subtracted or removed, and if the computer-controlled device or tool performs additive manufacturing, the values of the voxels specify where material is or is not to be added or deposited.

The voxel model defines layers of 2D “bitmaps.” For example, a first 2D bitmap for the position variables (xₖ+Δx, yₖ+Δy, 1+Δz) may define a first layer (for z=1), a second 2D bitmap for the position variables (xₖ+Δx, yₖ+Δy, 2+Δz) may then define a second layer (for z=2), and so on. The computer will typically control the product-making device so as to implement the voxel model one layer at a time.

The device-specific instructions produced by the driver will typically include the voxel model along with control instructions, including those derived from any additional information provided with the mathematical model. The driver is standard software adapted to receive particular modeling information and produce particular device-specific instructions for directing a particular type of computer-controlled device, and the device-specific instructions that the driver produces for that device will have no other practical use.

Just like the 3D mathematical model, the device-specific instructions are physically represented by ordered arrays or sequences of data for computer manipulation and implementation.

The driver is typically resident on the computer which is connected to, and which is used to control, the computer-controlled device. The device-specific instructions may be created on the same computer used to create the mathematical model, or a different computer. If the device-specific instructions are created on a different computer, the mathematical model may be provided to the computer used to create the device-specific instructions by standard means. Typically, the mathematical model will either be streamed from the memory of the computer used to create the mathematical model into a memory of the computer used to create the device-specific instructions over a wired or wireless connection between the two computers, which may be or include the Internet, or stored by the computer used to create the mathematical model in a portable computer-readable medium such as a CD-ROM or thumb drive, so that the computer-readable medium may be physically installed in the computer used to create the device-specific instructions for access thereby.

The device-specific instructions may be stored in a memory of the computer that is used to control the computer-controlled device, such as in a hard disk drive, and/or transmitted, such as by streaming, to the computer-controlled device. The device-specific instructions could also be stored in a portable computer-readable medium such as a CD-ROM or thumb drive as an intermediate step.

Once device-specific instructions have been provided along with a suitable supply of raw material to a computer-controlled device that is capable of making a product, like a CNC router or 3D printer, instructing the computer to apply the 3D model on the computer-controlled device is sufficient to cause the device to make the product. For example, applying a 3D model on a 3D printer requires nothing more than a conventional 3D printer driver and conventional raw material.

In the case of a 3D printer, the raw material is typically plastic, for forming the product as a single piece of plastic; however, 3D printers are capable of printing other materials, and there will doubtless be further improvements in 3D printing technology allowing for printing a wider variety of materials. In the case of a CNC router, the raw material is typically metal, for forming the product as a single piece of metal; however, CNC routers are used to machine other materials, including plastic. Where the head is formed of a material different from plastic, the mathematical model will typically be different as well. For example, a plastic head requires stiffening features, such as ribs and corrugations, that are not needed in a head formed of metal.

3D printers and CNC routers perform generic material rendering functions like general purpose digital computers perform generic data rendering functions.

FIG. 6 shows a block diagram of a generalized computer-controlled processing system 40 that may be used for performing generalized processes, including processes for making products. The system 40 has a computer 42 and a physical processing engine 44 that is controlled by the computer 42.

Input “A” to the computer 42 is a set of numbers defining either the process to be performed or the product to be made by the process, and executes one or more algorithms 42a equivalent to the aforementioned driver that have been loaded onto the computer so as to produce “system-specific” instructions as an output “B” of the computer for controlling the processing engine 44 to perform mechanical processes on physical input(s) “C” to produce physical output(s) “D.”

As one example of the processing system 40, the processing engine 44 may include a 3D printer and one or more robotic arms, where the inputs C are raw plastic material and line 29, and the output is a complete leaf rake head product. First, the 3D printer may be directed by the computer 42 to form a leaf rake head product having holes for enabling a clog-resistant feature as has been explained above. Second, the clog-resistant feature may be realized by instructing the one or more robotic arms to thread a length of pre-cut line through the holes; and the one or more robotic arms may also be used to cut the line to length and tie off the ends of the line.

An example of prior art robotic means for threading, cutting and tying a line is the “da Vinci® Surgical System.” The system employs two robotic arms, controlled by a computer. A surgeon performs the desired suturing operation remote from a patient. Sensors capture the motion paths of the surgeon's hands and fingers and provide that information to the computer, which controls each robotic arm and its associated end effectors so that the latter reproduce the motion paths at the desired location on the patient. The computer need not create or retain mathematical models of the motion paths because each path is specific to a particular time and place and is generally of no further use.

The DaVinci® robotic system provides an example of a robot that is capable of threading a line through holes, even though it is not programmable and is therefore not suited for performing repetitive tasks. However, robots are typically programmable to allow for performing repetitive tasks. All that is required to transform the DaVinci® robotic system into a robot that could be used to perform repetitive tasks is saving a motion path employed by the system, and in the art of robotic systems saving motion paths for repetitive use is conventional practice.

Robots perform generic material processing functions like general purpose digital computers perform generic data processing functions.

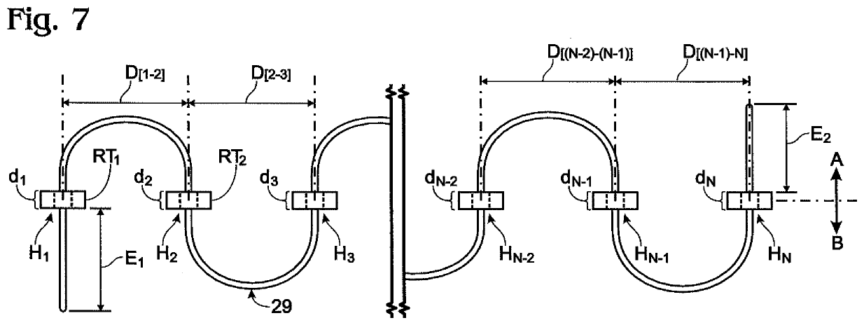

FIG. 7 shows a line 29 threaded through a series of N holes 22, namely H₁, H₂, H₃, . . . H_{N-2}, H_{N-1}, H_{N} passing through a leaf rake head product according to the embodiment 20, each hole in a respective one of the raking tines RT of the product. The depth of each hole is “d_{K}” where K=1 to N, and the center-to-center distance between the Kth hole and the (K+1)th hole is D_{[K-(K+1)}]. The line is shown threaded through the holes so as to leave substantially half-circular shaped loops of line between neighboring holes, i.e., a length that is substantially equal to π·(D_{[K-(K+1)}])/2, which strikes an optimum balance between minimizing the length of line between the holes and thereby minimizing the tendency for the line to trap debris or snag, and maximizing the flexibility of the raking tines by preserving the capability of the raking tines to bend independently of one another. String trimmer line in particular, due to a unique combination of stiffness and elasticity in bending, is naturally capable of adopting and maintaining substantially half-circular shaped loops merely by providing that the length of line between the holes satisfies this formula.

The line also has free ends of lengths “E₁” and “E₂” to allow for tying off the ends. Accordingly in this example, the total length of the line is L_{T}=E₁+d₁+[π·(D_{[1-2]})/2]+d₂+[π·(D[_{2-3]})/2]+d₃+[π·(D_{[3-4]})/2]+ . . . +d_{N-2}+[π·(D_{[(N-2)-(N-1)]})/2]+d_{N-1}+[π·(D_{[(N-1)-N]})/2]+d_{N}+E₂.

If, as would typically be the case, the depths d_{K} of all the holes are the same value “d,” the formula can be simplified to L_{T}=E₁+[N·d]+[π·(D_{[1-2]})/2]+[π·(D[_{2-3]})/2]+[π·(D_{[3-4]})/2]+ . . . +[π·(D_{[(N-2)-(N-1)]})/2]+[π·(D_{[(N-1)-N]})/2]+E₂.

If the center-to-center distances between the (N=K)th and the (N=K+1)th holes all have the same value D, the formula for L_{T} can be simplified further to L_{T}=E₁+[N·d]+[(N/2)·π·D/2]+E₂. That is, if there are N holes, the total line length in this example is sufficient to traverse N hole depths d and N/2 substantially half-circular loops, as well as provide for the end lengths E₁ and E₂.

A robotic arm may, or a team of robotic arms with one robotic arm on each side of the leaf rake head product may in turn, grip the end of the line somewhere along the length E₁ and feed the line through the holes H₁, H₂, etc. in turn by passing the line through each hole by lengths as follows (where L_{N}=the length of line to be passed through hole H_{N}): L₁={L_{T}−(E₁+d₁)}; L₂={L₁−(d₂+[π·(D_{[1-2]})/2])}; L₃={L₂−(d₃+[π·(D_{[2-3]})/2])}; . . . ; L_{N-2}={L_{N-3}−(d_{N-2}+[π·(D_{[(N-2)-(N-1)]})/2])}; L_{N-1}={L_{N-2}−(d_{N-1}+[π·(D_{[(N-1)-N]})/2])}; and L_{N}={L_{N-1}−d_{N}}.

The length of a motion path for passing the line through a given hole H_{K} must be long enough so that the amount of line that is passed through the hole H_{K} is long enough to pass through all the remaining holes H_{K+1}, H_{K+2}, . . . H_{N} in the sequence. Accordingly, a motion path for threading a line through a hole H_{K} in a leaf rake head product according to the embodiment 20 that satisfies the above formulations may have a length L_{K}={Σ_{K}(d_{K}+[π·(D_{[K-(K+1)]})/2)+E} for K through N.

For threading the line through two holes, e.g., the Kth and (K+1)th holes, the motion path may be considered to have two components, a first component being the motion path for passing the line the desired amount through the Kth hole, and a second component for passing the line the desired amount through the (K+1)th hole. The two components of the motion path for the example above have respective lengths that differ according to the formula ΔL=π·(D_{[K-(K+1)]})/2)+d_{K+1}.

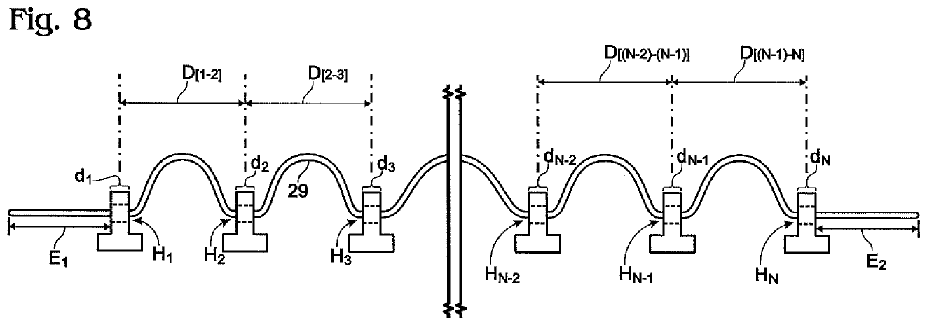

FIG. 8 shows a line 29 threaded through a similar series of N holes oriented according to the embodiment 30. The line is shown threaded through the holes so as to leave substantially sinusoidal shaped loops of line between the holes, particularly the shape of a full period of a sinusoid having a length that is substantially equal to F·π·(D_{[K-(K+1)]})/2, where F=1.22. String trimmer line in particular is naturally capable of adopting and maintaining substantially sinusoidal shaped loops merely by providing that the length of line between the holes satisfies this formula.

The total length of the line 29 in this example is therefore: L_{T}=E₁+(d₁+[F·π·(D_{[1-2]})/2]+(d₂+[F·π·(D[_{2-3]})/2])+(d₃+[F·π·(D_{[3-4]})/2])+ . . . +(d_{N-2}+[F·π·(D_{[(N-2)-(N-1)]})/2])+(d_{N-1}+[F·π·(D_{[(N-1)-N]})/2])+(d_{N})+E₂. A robotic arm, or a team of robotic, arms on the same side of the leaf rake head product, may grip the end of the end of the line somewhere along the length E₁ and feed the line through the holes H₁, H₂, etc. by passing the line through each hole by the same lengths described above for threading line through a leaf rake head product according to the embodiment 20.

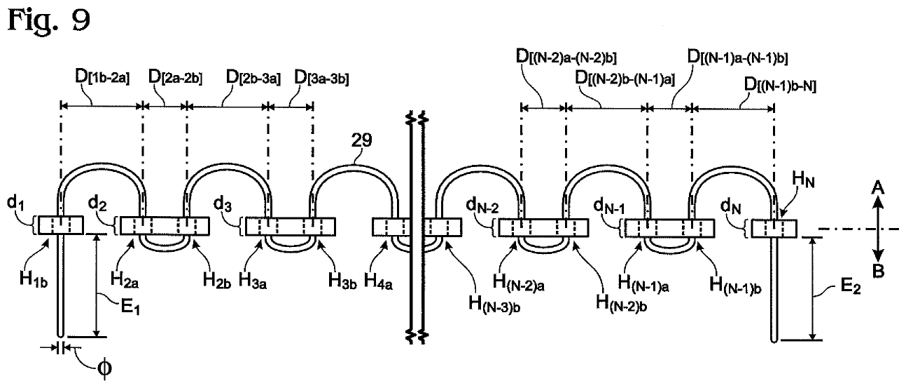

FIG. 9 shows a series of 2N−2 holes 22, namely H_{1b}, H₂ₐ, H_{2b}, H₃ₐ, H_{3b}, H₄ₐ, . . . , H_{(N-3)b}, H_{(N-2)a}, H_{(N-2)b}, H_{(N-1)a}, H_{(N-1)b}, H_{N} passing through a leaf rake head product according to the embodiment 40. The first and last holes in the sequence may be, respectively, the same as for the leaf rake product according to the embodiment 20, i.e., one hole through a corresponding one raking tine (where H_{1b} corresponds to H₁ in FIG. 7). For the remaining holes, there may be two holes through the same raking tine.

The depth of an (N=K)th hole is d_{K} as before. The center-to-center distance between an (N=K)th hole and the next (N=K+1)th hole depends on whether the two holes are in the same, or in neighboring, raking tines. If the two holes are in neighboring raking tines, the center-to-center distance between them is D_{[(N=K)b-(N=(K+1)a)]}; and if the two holes are in the same raking tine, the center-to-center distance between them is D_{[(N=K)a-(N=K)b)]}.

The line 29 is shown threaded through the holes in neighboring raking tines so as to leave substantially half-circular shaped loops, the same as for the embodiment 20 shown in FIG. 7. Again as for the embodiment shown in FIG. 7, the preferred string trimmer line is naturally capable of adopting and maintaining substantially half-circular shaped loops between neighboring raking tines merely by providing that the length of line between the neighboring holes through the respective raking tines satisfies the formula L=π·(D_{[K-(K+1)]})/2.

The line may be threaded through the holes in the same raking tine so as to leave substantially loop-less or “shortened” lengths by pulling the line tightly between the holes, which may be substantially equal to the center-to-center distance between the two holes plus the diameter (referenced as “φ”) of the line. Then, the total length of the line is L_{T}=E₁+d₁+[πD_{[1b-2a]}/2]+(2·d₂)+(D_{[2a-2b]}+φ)+[π·(D_{[2b-3a]})/2])+(2·d₃)+(D_{[3a-3b]}+φ)+[π·(D_{[3b-4a]})/2]+ . . . +(2·d_{N-2})+(D_{[(N-2)a-(N-2)b]}+φ)+π·(D_{[(N-2)b-(N-1)a]})/2]+(2·d_{N-1})+(D_{[(N-1)a-(N-1)]b]}+φ)+[π·(D_{[(N-1)b-N]})/2]+d_{N}+E₂.

Combining the φ's, the formula is L_{T}=E₁+[(N/2−1)·φ]+d₁+[π·(D_{[1b-2a]})/2]+[2·d₂]+D_{[2a-2b]}+[π·(D_{[2b-3a]})/2]+[2·d₃]+D_{[3a-3b]}+[π·(D_{[3b-4a]})/2]+ . . . +[2·d_{N-2}]+D_{[(N-2)a-(N-2)b]}+[π·(D_{[(N-2)b-(N-1)a]})/2]+[2·d_{N-1}]+D_{[(N-1)a-(N-1)]b]}+[π·(D_{[(N-1)b-N]})/2]+d_{N}+E₂.

If, as would typically be the case, the depths d_{K} of all the holes are the same value “d,” the formula can be simplified to L_{T}=E₁+[(N/2−1)·φ]+[N·d]+[π·(D_{[1b-2a]})/2]+D_{[2a-2b]}+[π·(D_{[2b-3a]})/2]+D_{[3a-3b]}+[π·(D_{[3b-4a]})/2]+ . . . +D_{[(N-2)a-(N-2)b]}+[π·(D_{[(N-2)b-(N-1)a]})/2]+D_{[(N-1)a-(N-1)]b]}+[π·(D_{[(N-1)b-N]})/2]+E₂. If the spacings between the (N=K)th and (N−K+1)th holes, where these holes are in neighboring raking tines, are all the same value D_{[Kb-(K+1)a]}, and if the spacings between the (N=K)th and (N=K+1)th holes, where these holes are in the same raking tines, are all the same value D_{[Ka-Kb]}, the formula for L_{T} can be simplified further to L_{T}=E₁+[N·d]+[(N/2)·π·(D_{[Kb-(K+1)a]})/2]+[(N/2−1)·(D_{[Ka-Kb]}+φ)]+E₂. That is, if there are N holes, the total line length in this example is sufficient to traverse N hole depths d, N/2 substantially half-circular loops, and (N/2−1) shortened lengths, as well as provide for the end lengths E₁ and E₂.

A robotic arm may, or a team of robotic arms with one robotic arm on each side of the leaf rake head product may in turn, grip the end of the line somewhere along the length E₁ and feed the line through the holes H_{1b}, H₂ₐ, H_{2b}, etc., in turn, passing the line through each hole by lengths as follows (where L_{Na}, L_{Nb}=the length of line to be passed through hole H_{Na}, H_{Nb}): L_{1b}={L_{T}−(E₁+d₁)}; L₂ₐ={L_{1b}−(d₂+[π·(D_{[1b-2a]})/2])}; L_{2b}={L₂ₐ−(d₂+D_{[2a-2b]}+φ)}; L₃ₐ={L_{2b}−(d₃+[π·(D_{[2b-3a]})/2])}; L_{3b}={L₃ₐ−(d₃+D_{[3a-3b]}+φ)}; . . . ; L_{(N-2)a}={L_{(N-3)b}−(d_{(N-2)}+[π·(D_{[(N-2)b-(N-1)a]})/2])}; L_{(N-2)b}={L_{(N-2)a}−(d_{(N-2)}+D_{[(N-2)a-(N-2)b]}+φ)}; L_{(N-1)a}={L_{(N-2)b}−d_{(N-1)}+[π·(D_{[(N-2)b-(N-1)a]})/2])}; L_{(N-1)b}={L_{(N-1)a}−d_{(N-1)}+D_{[(N-1)a-(N-1)b]}+φ)}; and L_{N}={L_{(N-1)b}−(dₙ+[π·(D_{[(N-)b-N]})/2])}.

A motion path for threading a line through a hole H_{K} in a leaf rake head product according to the embodiment 40 that satisfies the above formulations may have a length L_{K}=[Σ_{K}(d_{K1}+[π·(D_{K1-(K1+1)]})/2]+[Σ_{K}(d_{K2}+D_{K2}+φ)]+E for K through N, where D_{K1} is the center-to-center distance between a hole “b” in the Kth raking tine and the sequentially next hole “a” in the (K+1)th raking tine, and D is the center-to-center distance between a hole “a” in the Kth raking tine and the sequentially next hole “b” in the Kth raking tine.

For threading the line between three holes, e.g., the Kth, (K+1)th and (K+2)th holes, which can be (A) two holes H_{K} and H_{K+1} that are in the same raking tine+one hole H_{K+2} that is in the next raking tine in the sequence, or (B) two holes H_{K} and H_{K+1} that are, respectively, in first and second raking tines of the sequence+one hole H_{K+2} that is in the second raking tine. The first and last components of the motion path for the example above will have respective lengths that differ in circumstance (A) by an amount determined by the formula ΔL_{A}=[(π·(D_{[K-K+1]})/2)+D_{[(K+2)-(K+3)]}+φ], and in circumstance (B) by an amount determined by the formula ΔL_{B}=[D_{[(K+1)-(K+2)]}+φ+(π·(D_{[(K+1)-(K+2)]})/2)].

Where the holes are virtual holes in a virtual leaf rake head product having virtual depths and virtual center-to-center distances as defined by a mathematical model installed on a computer, as opposed to real holes of a real leaf rake head product having real depths and real center-to-center distances, the motion paths are not real motion paths but are virtual motion paths for threading an imaginary line through the virtual holes as defined by another mathematical model in accord with the formulations above. For defining a virtual motion path, the imaginary line need not also be modeled on the computer other than to note, if needed, its diameter and/or length.

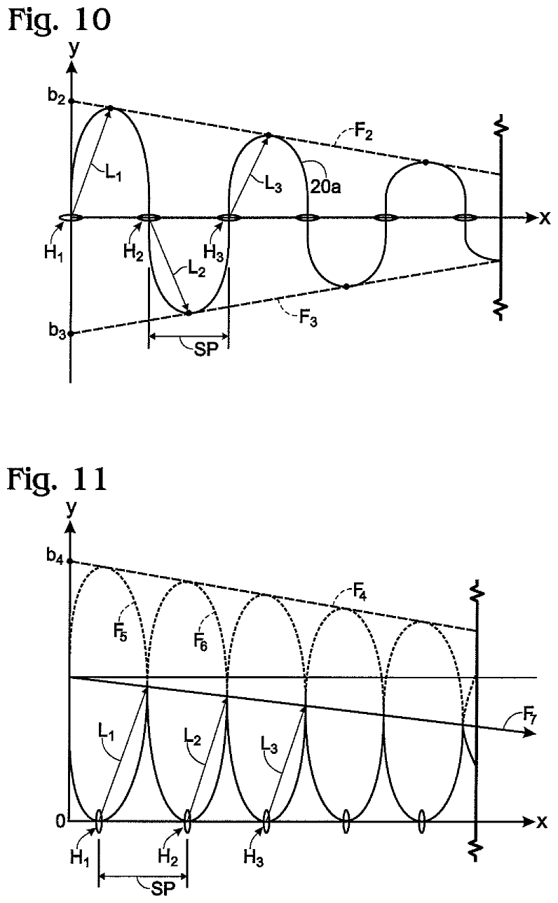

FIG. 10 shows, plotted in an “x-y” coordinate system, 2-dimensional geometric figures defining a motion path 20a for threading the line 29 through the holes 22 of a leaf rake head product according to the embodiment 20 shown in FIG. 2. The example is simplified for illustration purposes by providing that the holes H are all spaced the same distance “SP” apart. The holes H_{N} lie on the x-axis, i.e., y=0.

The motion path 20a is a linearly damped sinusoid: y₁=A₁(x)·sin (x·[π/SP]), where A₁(x) bounds the sinusoid between lines “F₂” and “F_{3,}” which are, respectively, defined by the relationships y₂=m₂x+b₂, and y₃=m₃x+b₃, where “m₂” and “m₃” are the respective slopes of the lines, and “b₂” and “b₃” are the respective y-intercepts.

The amplitude of the sinusoidal motion path 20a linearly decreases with increasing values of x to provide for line pulling distances L_{N} that decrease according to the mathematical relationships described above for a leaf rake head product according to the embodiment 20.

The symmetry of the loops of line on the sides of the holes indicated as “A” and “B” in FIG. 7 implies that the lines F₂ and F₃ are minor images of each other about the x-axis.

A motion path 40a for threading line through a leaf rake head product according to the embodiment 40 may be qualitatively the same as the motion path 20a, with a quantitative difference resulting from the asymmetry of the loops of line on the sides of the holes indicated as “A” and “B” in FIG. 9, that the lines F₂ and F₃ are not mirror images of each other about the x-axis; in particular the line F₃ is closer to the x-axis than the line F₂ and is less steeply sloped.

FIG. 11 shows a motion path 30a for threading the line 29 through the holes 22 of a leaf rake head product according to the embodiment 30 shown in FIG. 4, again simplified for illustration purposes by providing that the holes H are all spaced the same distance “SP” apart.

The holes H_{N} lie on the x axis, i.e., y=0. The path 30a is defined by two linearly damped sinusoids indicated as “F₅” and “F_{6,}” y₅=A_{5,6}(x)·sin (x·[π/SP]) and y₆=A_{5,6}(x)·sin (x·[π/SP]+π/2) respectively, oscillate around a baseline “F₇” that is also linearly decreasing. A_{5,6}(x) establishes an upper bound of the sinusoids at the line “F₄,” defined by the relationship y₄=m₄x+b₄, and defining the baseline as y₄/2.

The motion path 30a follows the lower halves of the sinusoidal figures F₅ and F₆; the amplitude A_{5,6}(x) associated with a given hole H_{N} is established by the length L_{N} for that hole, as illustrated by the length L₁ for the hole H₁.

The 3D model of the leaf rake heads 20, 30, and 40 may be used to ascertain the geometrical locations of the holes for performing the threading process once the leaf rake head is in a known position.

The motion paths 20a, 30a and 40a are two-dimensional on the simplifying assumption that the centers of the holes 22 all lie on the same plane, which is not generally true. Accordingly, motion paths for threading line through the holes of leaf rake head products according to the present invention may be three-dimensional, and computer models of such motion paths may be either 2D or 3D models.

In general, computer models of products and motion paths specify mathematical formulas or equations defining relationships between spatial variables. Then, transforming the models into device specific algorithms adapted for, e.g., driving a 3D printer or robotic arm to implement the models includes applying the formulas or solving the equations. Alternatively, such models may specify spatial coordinates that satisfy such relationships. The coordinates are typically but are not necessarily obtained by applying mathematical formulas or solving mathematical equations. They could, for example, be obtained as in the da Vinci Surgical System by copying an existing real motion path, or as in cases where a 3D printer is used to copy an existing real product, the metrics of which are determined by laser scanning the product. In either case, such models will be referred to herein as “mathematical models.”

Also for purposes herein, an imaginary product or process which is mathematically modeled on a computer may be referred to as being “virtual” or as having virtually defined features, in contrast to a “real” product or process made or performed according to the model. For example, a mathematical model of a leaf rake head product virtually defines a leaf rake head product that may be made “real” by implementing the model on a 3D printer; and a mathematical model of a motion path for threading an imaginary line through virtual holes of the virtual leaf rake head product virtually defines a motion path that may be made “real” by implementing the motion path on a robot or robotic arm.

A mathematical model is made ready for implementation on a computer by installing the model on the computer, either by using the computer to create the model in the first place or by loading a previously existing model onto the computer. With reference to FIG. 6, once one or more mathematical models are installed on the computer 42, the computer may be used to transform the one or more mathematical models into device-specific algorithms for driving the processing engine 44 to make a real product or perform a real process according to the one or more models.

Mathematical models of motion paths, like mathematical models of objects, may be transformed into instructions for driving a particular computer-controlled tool intended to be used to implement the model by use of driver software provided for that particular tool.

It should be understood that, while particular embodiments of the invention have been shown and described as preferred, variations can be made, in addition to those already mentioned, without departing from the principles of the invention.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims which follow.

1. A leaf rake head product for enabling a clog-resistant feature in a hand-held leaf rake, the leaf rake head product comprising a plurality of independent raking tines extending froth a common body portion, wherein each raking tine has an entire length over which the raking tine is an elongate member first extending substantially linearly, thence turning through a distinct bent portion, and thence again extending substantially linearly to define an elongate raking portion of the raking tine terminating in a raking tip, the bent portion extending over less than 20% of said length, the product further comprising, in each of the plurality of raking tines, at least one hole extending through and enclosed by the respective raking portion.

2. The product of claim 1, wherein each of the plurality of raking tines extends from the common body portion in a respective plane of extension, and the at least one hole in each of the plurality of raking tines is oriented so that a line may be threaded freely therethrough in a direction parallel to the respective plane of extension.

3. The product of claim 2, including the line threaded through the at least one hole in each of the plurality of raking tines so as to form loops of the line between the respective raking portions.

4. The product of claim 3, wherein the at least one hole in each of the plurality of raking tines comprises two spaced apart holes, and the line is threaded through the two spaced apart holes in each of the plurality of raking tines.

5. The product of claim 2, wherein the at least one hole in each of the plurality of raking tines comprises two spaced apart holes.

6-20. (canceled)

21. A process for enabling a clog-resistant feature in a hand-held leaf rake, comprising installing a first mathematical model on a computer, the first mathematical model describing first mathematical equations that define a leaf rake head product comprising a plurality of independent raking tines extending from a common body portion, wherein each raking tine has an entire length over which the raking tine is an elongate member first extending substantially linearly, thence turning through a distinct bent portion, and thence again extending substantially linearly to define an elongate raking portion of the raking tine terminating in a raking tip, the bent portion extending over less than 20% of said length, the product further comprising, in each of the plurality of raking tines, at least one hole extending through and enclosed by the respective raking portion.

22. The process of claim 21, the first mathematical equations further defining the leaf rake product wherein each of the plurality of raking tines extends from the common body portion in a respective plane of extension, and the at least one hole in each of the plurality of raking tines is oriented so that a line may be threaded freely therethrough in a direction parallel to the respective plane of extension.

23. The process of claim 22, further comprising installing a second mathematical model on a computer, the second mathematical model describing second mathematical equations that define a motion path for threading the line through the at least one hole in each of the plurality of raking tines so as to define loops of the line between the respective raking portions.

24. The process of claim 23, the first mathematical equations further defining the leaf rake head product wherein the at least one hole in each of the plurality of raking tines comprises two spaced apart holes, and the second mathematical equations further defining the motion path for threading the line through the two spaced apart holes in each of the plurality of raking tines.

25. The process of claim 22, the first mathematical equations further defining the leaf rake head product wherein the at least one hole in each of the plurality of raking tines comprises two spaced apart holes.

26. The process of claim 21, further comprising applying the first mathematical model on a commercially available 3D printer to result in transforming the first mathematical model into a real leaf rake head product as defined by the first mathematical equations.

27. The process of claim 22, further comprising applying the first mathematical model on a commercially available 3D printer to result in transforming the first mathematical model into a real leaf rake head product as defined by the first mathematical equations.

28. The process of claim 23, further comprising applying the first mathematical model on a commercially available 3D printer to result in transforming the first mathematical model into a real leaf rake head product as defined by the first mathematical equations; and applying the second mathematical model on a commercially available robot to result in transforming the second mathematical model into a real motion path as defined by the second mathematical equations, and thereby to result in the real leaf rake head product including a real line threaded through the at least one hole in each of the plurality of raking tines of the real leaf rake head product so as to form loops of the real line between the respective raking portions of the real leaf rake head product.

29. The process of claim 24, further comprising applying the first mathematical model on a commercially available 3D printer to result in transforming the first mathematical model into a real leaf rake head product as defined by the first mathematical equations; and applying the second mathematical model on a commercially available robot to result in transforming the second mathematical model into a real motion path as defined by the second mathematical equations, and thereby to result in the real leaf rake head product including a real line threaded through the two spaced apart holes in each of the plurality of raking tines of the real leaf rake head product so as to form loops of the real line between the respective raking portions of the real leaf rake head product.

30. The process of claim 25, further comprising applying the first mathematical model on a commercially available 3D printer to result in transforming the first mathematical model into a real leaf rake head product as defined by the first mathematical equations.

31. A process for enabling a clog-resistant feature in a hand-held leaf rake, comprising creating a first mathematical model on a computer, the first mathematical model describing first mathematical equations that define a leaf rake head product comprising a plurality of independent raking tines extending from a common body portion, wherein each raking tine has an entire length over which the raking tine is an elongate member first extending substantially linearly, thence turning through a distinct bent portion, and thence again extending substantially linearly to define an elongate raking portion of the raking tine terminating in a raking tip, the bent portion extending over less than 20% of said length, the product further comprising, in each of the plurality of raking tines, at least one hole extending through and enclosed by the respective raking portion.

32. The process of claim 31, the first mathematical equations further defining the leaf rake product wherein each of the plurality of raking tines extends from the common body portion in a respective plane of extension, and the at least one hole in each of the plurality of raking tines is oriented so that a line may be threaded freely therethrough in a direction parallel to the respective plane of extension.

33. The process of claim 32, further comprising creating a second mathematical model on a computer, the second mathematical model describing second mathematical equations that define a motion path for threading the line through the at least one hole in each of the plurality of raking tines so as to define loops of the line between the respective raking portions.

34. The process of claim 33, the first mathematical equations further defining the leaf rake head product wherein the at least one hole in each of the plurality of raking tines comprises two spaced apart holes, and the second mathematical equations further defining the motion path for threading the line through the two spaced apart holes in each of the plurality of raking tines.

35. The process of claim 32, the first mathematical equations further defining the leaf rake head product wherein the at least one hole in each of the plurality of raking tines comprises two spaced apart holes.
